(19) United States
(12) Patent Application Publication
(10) Pub. No.: US 2007/0230056 A1
(43) Pub. Date: Oct. 4, 2007

(54) Slider incorporating heaters and ELGs and method of fabrication

(76) Inventors: Robert Stanley Beach, Los Gatos, CA (US); David John Seagle, Morgan Hill, CA (US); Jila Tabib, Los Gatos, CA (US)

Correspondence Address: INTELLECTUAL PROPERTY LAW OFFICES, 1901 SOUTH BASCOM AVENUE, SUITE 660, CAMPBELL, CA, 95008, US

(21) Appl. No.: 11/397,823

(22) Filed: Apr. 3, 2006

(51) Int. Cl. G11B 5/60

(52) U.S. Cl. 360/234.5

(57) ABSTRACT

A slider for a magnetic disk drive is disclosed which includes a heater circuit structure, and at least one ELG circuit structure where a portion of the ELG circuit structure is removable by lapping. The ELG circuit structure is connected electrically in parallel with the heater circuit structure to a common set of electrical contact pads to produce a measured initial parallel resistance as measured at the common set of electrical contact pads. A modified parallel resistance is calculated to correspond to that of the modified individual resistance of the ELG when lapping operation is completed. The resistance is monitored during lapping operations to signal when the appropriate lapping depth is achieved. Also disclosed is a disk drive having the slider, and a method of fabrication for a slider.

### BACKGROUND OF THE INVENTION

1. Field of the Invention

The present invention relates generally to manufacture of magnetic heads for data storage devices and more specifically to sliders having heaters and Electronic Lapping Guides for a hard disk drive.

2. Description of the Prior Art

Present disk drive technology incorporates sliders with magnetic heads having two independent electrical elements—a read head and a write head. Since the read head and write head elements require high frequency operation, coupling between the two devices must be minimized in order to decrease errors. For this reason, 4 electrical contact pads, 2 independently for the read head and 2 independently for the write head, are used for bonding the electrical connection to the drive.

An additional electrical element, a Thermal Fly Height Control Resistor (TFC) is also commonly used to more precisely control the height at which the head flies over the disk media. By heating a portion of the slider, thermal expansion causes the slider to move closer to the disk surface, thus enabling a fine adjustment of the slider's fly height. This device is nominally lower frequency in operation, but to avoid degrading the read or write element, it is commonly given its own independent pads for connection to the drive. Thus a typical prior art read/write head incorporating a TFC squeezes 6 electrical contact pads into a space less than approximately 700 microns.

Another consideration is the degree of material removal when the slider is lapped to its final dimensions. As an indicator of the progress of the lapping operations, lapping guides are sometimes used. For certain types of magnetic heads, it is not practical to use the read head of the slider as a lapping guide. Instead, a nearby Electronic Lapping Guide (ELG) is used. In some schemes, the ELG is incorporated into the slider, most notably in Single Slider Lapping, when the final lap procedure is performed on a completely severed slider.

Placing an ELG on the slider adds an additional electronic element to the slider and requires yet more pads. For a fixed slider size, adding more padding typically requires reducing the pad size and separation. However, bonding operations become ever more difficult as pad size and separation are reduced.

Thus, in the prior art, there will generally be 4 independent electrical elements on the slider, namely the read head, the write head, the TFC and the ELG, requiring a total of 8 electrical contact pads to be fabricated on the slider.

Thus there is a need for a slider which allows incorporation of all four electrical elements, and which allows all four elements to be fully functional with a fewer number of contact pads without degrading performance of any of these four elements.

### SUMMARY OF THE INVENTION

The present invention is a slider for a magnetic disk drive, including a heater circuit structure, and at least one ELG circuit structure, where a portion of the ELG structure is removable by lapping. The ELG circuit structure is initially electrically isolated from the heater circuit structure, and the ELG circuit structure is then connected electrically in parallel with the heater circuit structure to a common pair of electrical contact pads. The ELG and the heater resistances produce a measured initial parallel resistance as measured at the common set of electrical contact pads. A modified parallel resistance is calculated to correspond to that of the modified individual resistance of the ELG when lapping operation is completed. The resistance is monitored during lapping operations to signal when the appropriate lapping depth is achieved.

Also disclosed is a disk drive having the slider, a method of fabrication for a slider for a magnetic disk drive for determining the appropriate final depth of material removal in the slider utilizing a reduced number of contact pads, and a method of fabrication for a slider for a magnetic disk drive for reducing the number of electrical contact pads in the slider.

It is an advantage of the slider of the present invention that the amount of material to be removed can be easily monitored from a set of contact pads on the slider.

It is another advantage of the slider of the present invention that the number of required contact pads is reduced.

It is a further advantage of the slider of the present invention that the slider can be produced at a reduced size due to the reduced number of contact pads.

It is yet another advantage of the method of the present invention that the completion of the lapping process on the Air Bearing Surface can be signaled by monitoring the resistance at the set of contact pads.

It is still another advantage of the method of the present invention that the accuracy of extent of the material removal at the Air Bearing Surface is improved.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 shows a top plan view of an exemplary disk drive;

FIG. 2 illustrates a perspective view of view of an exemplary slider and suspension;

FIG. 3 shows a top plan view of an exemplary read/write head;

FIG. 4 is a top plan schematic view of an exemplary slider of the present invention;

FIG. 5 is a schematic drawing of a portion of the slider of the present invention before lapping of the ABS;

FIG. 6 is a schematic drawing of a portion of the slider of the present invention after lapping of the ABS;

FIG. 7 is a top plan view of the slider in a first stage of fabrication corresponding to that of FIG. 8B below;

FIG. 8A is a detail view of a portion of an electrical contact structure of the slider showing the general areas of the heater pillar and ELG pillar;

FIG. 8B is a cross-sectional view of the portion of the electrical contact of FIG. 8A as taken through section line 8B-8B in a first stage of fabrication of the present invention;

FIGS. 9-16 are cross-sectional views of successive stages of fabrication of the present invention;

FIG. 17 is a top plan view of the slider of the present invention after lapping of the ABS but before patterning the ABS; and

FIG. 18 is a top plan view of the slider of the present invention after milling of the ABS.

### DETAILED DESCRIPTION OF THE PREFERRED EMBODIMENTS

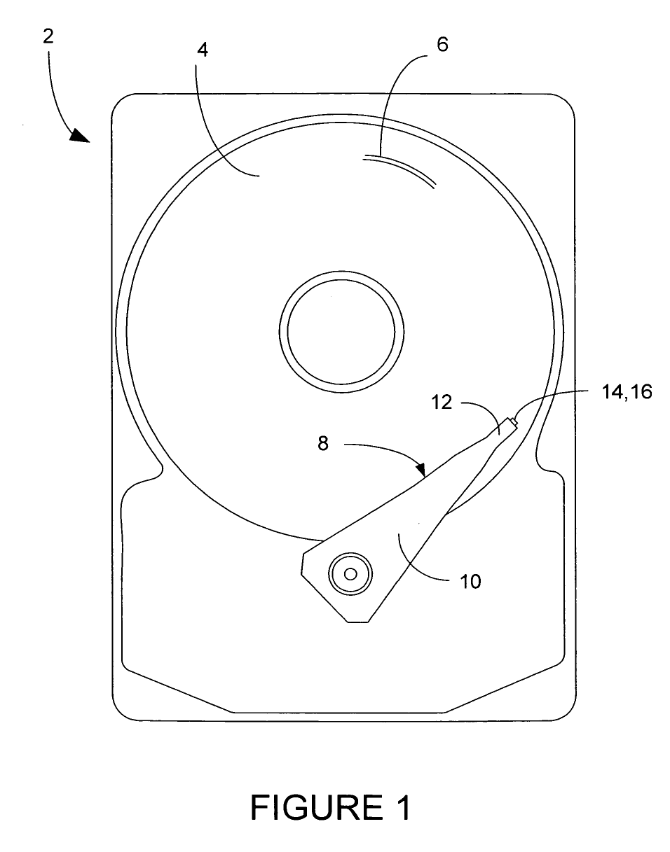

An exemplary magnetic disk drive 2 is shown generally in FIG. 1, having one or more magnetic data storage disks 4, with data tracks 6 which are written and read by a data read/write device 8. The data read/write device 8 includes an actuator arm 10, and a suspension 12 which supports one or more magnetic heads 14 included in one or more sliders 16.

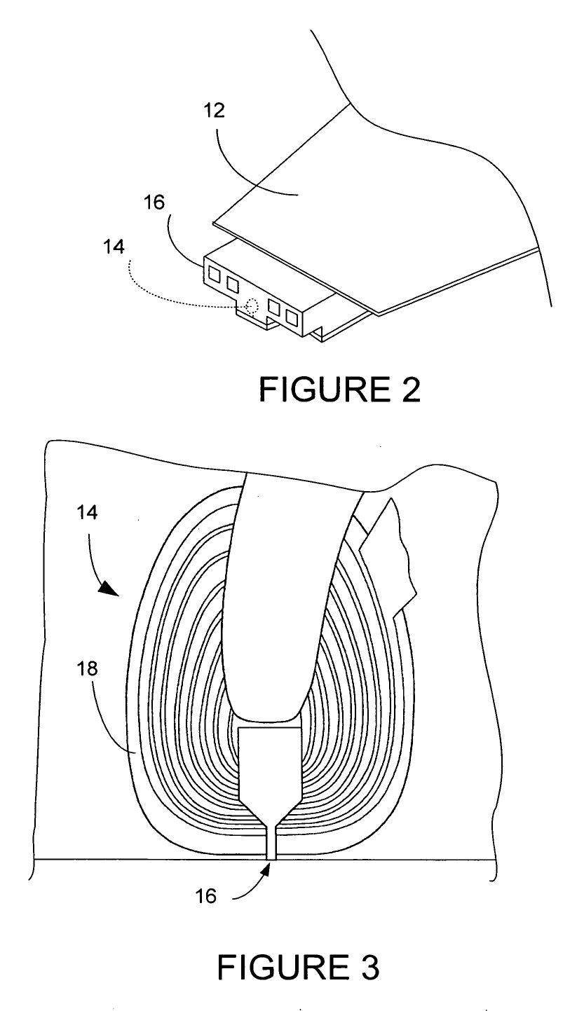

FIG. 2 shows a slider 16 in more detail being supported by suspension 12. The magnetic head 14 is shown in dashed lines, and in more detail in FIG. 3. The magnetic head 14 includes a coil 18.

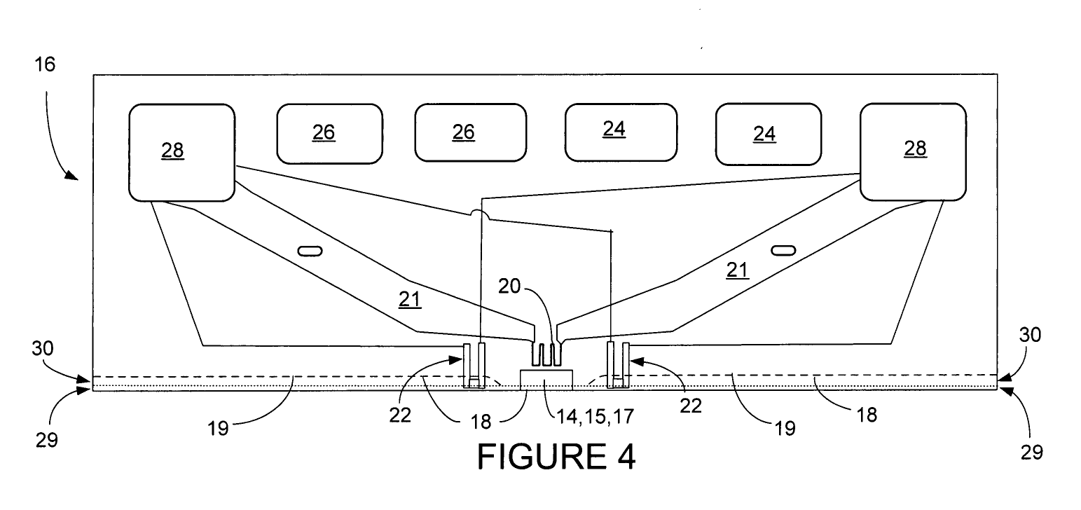

FIG. 4 is a top schematic representation of the slider of the present invention. The elements shown are actually fabricated on different levels are thus obscure each other so that not all are visible from this viewpoint at the same time. There also has been no attempt to draw all the elements to scale, but they are generally located in the relation to each other that is shown here.

The slider 16 has an air bearing surface (ABS) 18 which flies above the surface of the hard disk. The magnetic heads 14 generally include a read head 15 and a write head 17.

As discussed above, in addition to the read head and write head, an additional electrical element, a Thermal Fly Height Control Resistor (TFC) is also commonly used to more precisely control the height at which the head flies over the disk media. This device is nominally lower frequency in operation, but to avoid degrading the read or write element, it is commonly given its own independent pads for connection to the drive. Connecting leads 21 are attached to the TFC, referred to here as the heater 20.

Additionally, when the slider is being lapped to its final dimensions, one or more (two are shown) Electronic Lapping Guides (ELG) 22 are incorporated into the slider 16 to signal when the lapping operation is finished. Thus, there will be 4 independent electrical elements on the slider 16, namely the read head 15, write head 17, TFC or heater 20 and ELG 22. In the prior art, this required a total of 8 pads to be fabricated on the slider.

The present invention uses a novel configuration and method to reduce the number of pads needed for these four elements by configuring the ELG and TFC as parallel electrical circuits, which share a set of 2 pads, thereby reducing the total number of pads to 6. A first set of pads 24 is used for the read head connection, a second set of pads 26 is used for the write head connections, and a third set 28 is used for the parallel TFC and ELG connections.

As mentioned above, the ABS 18 of the slider will be lapped to smooth the surface and establish the final dimensions of the slider 16. For this reason, an area is shown in dashed lines in the figure which will correspond to the removal area 29, which will be lapped away. It will be noted that a portion of the ELGs 22 extend into the removal area 29, and this portion will be removed intentionally, as an indicator of the progress of the lapping process.

The parallel resistance of the heater 20 and the ELG 22 can be expressed as R_{Heater} 11 R_{ELG}, and this resistance will change as the lapping process removes parts of the ELG elements, thus increasing the resistance in that branch of the R_{Heater} 11 R_{ELG} combination. A target value for the final R_{Heater} 11 R_{ELG} combination is calculated based on the known value of the R_{Heater} and the calculated value of R_{ELG} when the lapping of the ABS has reached completion. Thus by monitoring the resistance at the pads 28 shared by ELG and TFC parallel electrical circuits, it can be determined when the lapping process has reached the appropriate depth, and is thus complete.

The formation of the ABS is actually a 2-stage process. The first is the lapping of a flat surface including the surface of the magnetic heads 14 in which the ELGs 22 are used to determine the termination of the lapping. It determines the final size of the read head 15 and write head 16 and will include the removal area 29. The height of the read head 15 is a very critical dimension and thus is an important reason for using ELGs 22 to guide the lapping process to a precise termination.

If the slider were to be placed on the rotating disk at this point, the fly height (or spacing) would not necessarily be correct. It would typically be too high. Additionally there would be other problems such as sensitivity of fly height to ambient pressure. Therefore, a second processing step is invoked where the ABS surface is selectively milled back with the aid of a photoresist mask. Thus a pair of ‘deep gap regions’ or ‘etch regions 30’ of the ABS 18 are removed to form the patterned ABS 19 regions. Portions of the remaining ELGs 22 are located in these etch regions 30.

Because the milling operation in the etch region 29 is so deep, and because a portion of the ELGs 22 are located in the etch region 29, the ELGs 22 are typically also milled until they become open circuits in this second processing step, leaving only the resistance of the heater in the parallel combination.

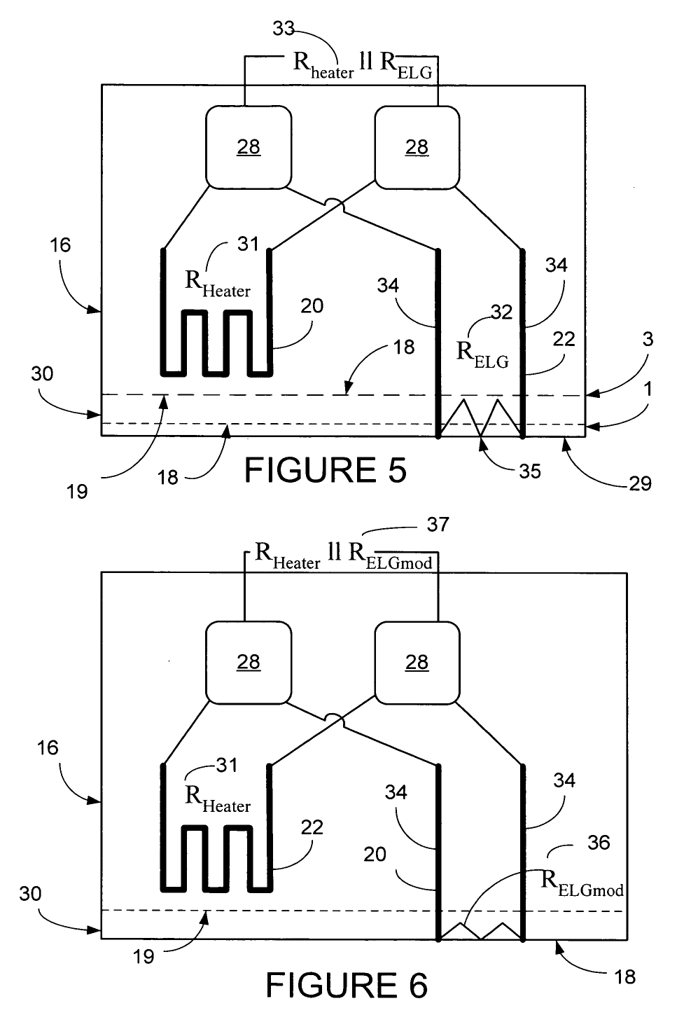

The configuration prior to lapping and etching is represented by the schematic diagrams in FIGS. 5 and 6 and both will be referred to in the following discussion. In FIG. 5, the resistance of the heater, R_{Heater} 31 and the resistance of the ELG, R_{ELG} 32 are shown connected in parallel to a set of pads 28. The ELG 22 is modeled as a pair of leads 34 with a resistor 35 connected between them. These modeled elements are shown on an outline representing the physical outline of the slider 16 before lapping. The dashed line 1 shows the intended extent of the removal area 29 thus represents the extent of the ABS 18 in the area of the magnetic heads after lapping is completed. The dashed line 3 shows the intended extent of the etch region 30, thus represents the extent of the patterned ABS 19 after milling is completed. The combined resistance as measured between the pads 28 before lapping or milling thus is represented by R_{Heater} 11 R_{ELG} 33.

FIG. 6 shows the modeled parallel circuit after lapping has established the final ABS 18 in the area of the magnetic heads 14, but before etching has established the patterned ABS. A portion of the resistor element 35 (see FIG. 5) connecting the two leads 34 of the ELG 22 has been removed, so that the resistance of the ELG 22 is modified and is represented by the designation R_{ELGmod} 36, and the modified parallel resistance is designated as R_{Heater} 11 R_{ELGmod} 37.

In a further stage when the etch region 29 has been removed, leaving the patterned ABS 19, (see FIG. 4), the resistor element is preferably removed entirely, leaving an open circuit in parallel with the R_{Heater}, thus theoretically equal to the resistance of the heater alone, when measured at pads 28.

By monitoring the resistance at the pads during lapping operations, it can thus be determined when the lapping operation has removed a sufficient amount of the ELG to signal completion of the operation.

In the present example, this is accomplished when the R_{ELGmod} 36 is not infinite (open circuit), and thus R_{Heater} 11 R_{ELGmod} 37 does not equal R_{Heater} 31, until later in the second step when the etch region is removed, but it will be understood that this is not a requirement and R_{ELGmod} 36 may equal infinity (open circuit) or any intermediate value, as long as it is understood to produce the appropriate signal when lapping operations have been completed.

In order to establish ELG and TFC as parallel electrical circuits, the present invention presents a novel structure and fabrication method. Fabrication of sliders generally involves the construction of multiple layers in a defined sequence. The pads are generally fabricated in the top layer and structures known as “pillars” are constructed as electrical pathways between these pads and electrical elements in the lower layers. In the case of elements which are to be connected in parallel, these pillars must be kept electrically isolated from each other, and thus the conduction of the pillars becomes a complex operation with portions of electrically conductive material and electrical insulation in the same layer.

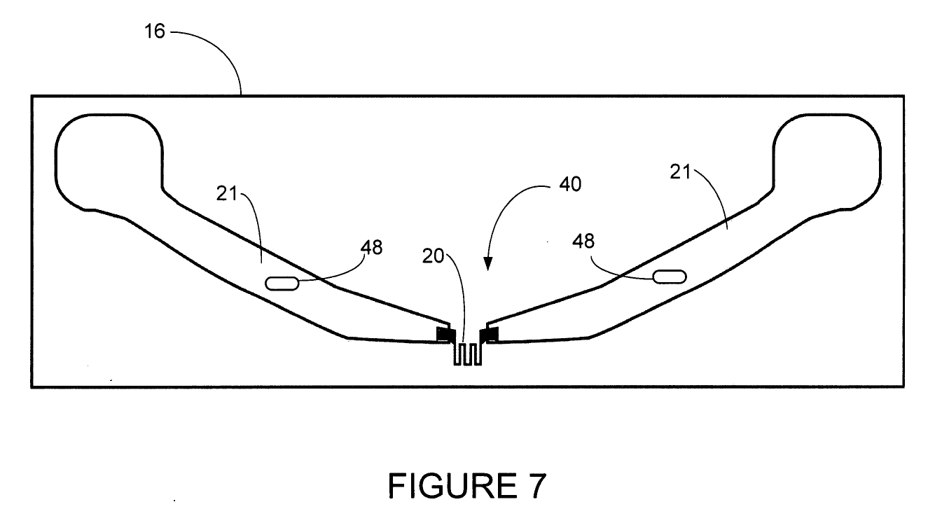

FIG. 7 shows a layer of the slider 16 which includes the heater element 20 which is connected to two conductive leads 21, which are preferably thin sheets of copper. The heater pillars 48 are built on these conductive leads 21, as will be discussed below. The conductive leads 21 are extended to connect to the site of the contact pads (not shown here) so that the resistance of the heater 20 can be tested. The heater 20, connective leads 21 and heater pillars 48 will be referred to collectively as the heater circuit structure 40.

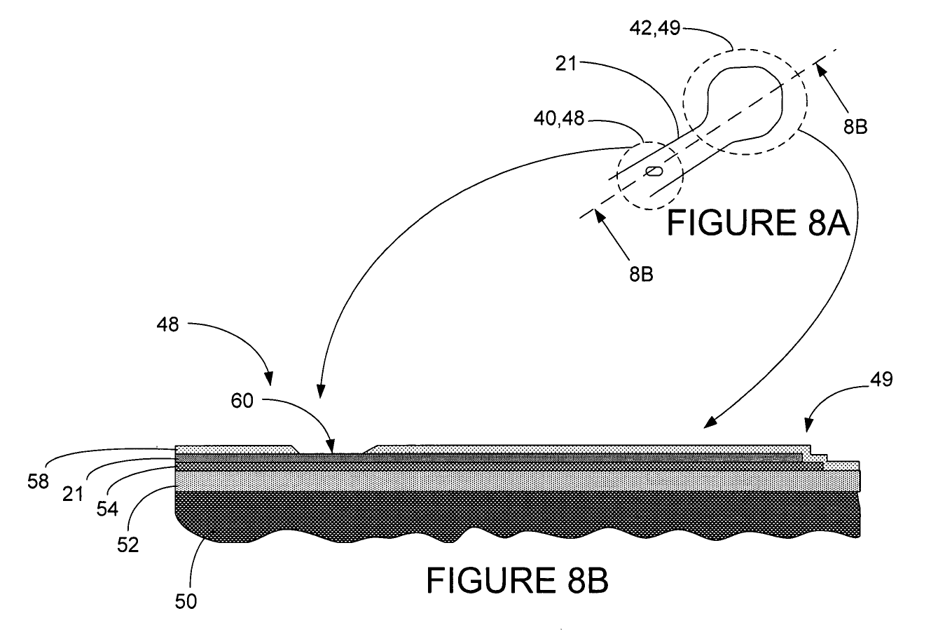

FIGS. 8-16 show the stages of fabrication of the portions of the slider which include the pillars for the heater (TFC) and the ELGs, and their eventual connection with the electrical contact pads to complete their ELG and TFC parallel electrical circuit.

FIGS. 8A-B show a simplified illustration of the layers of the slider in the area of the conductive lead 21, as shown previously in FIG. 7, which include the heater pillar 48 and ELG pillar 49. The ELGs 22, and ELG pillars 49 will be referred to collectively as the ELG circuit structure 42, although it should be understood that the ELGs are not visible in FIGS. 8-16, as they lie in a different portion of the slider, but are connected to the ELG lead layer, to be discussed below.

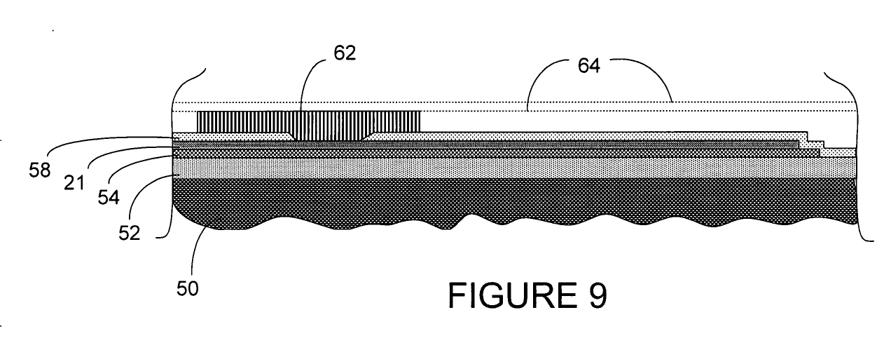

FIG. 8B shows a cross-sectional view of the conductive lead 21 and subsequent layers shown in FIG. 8A, as taken through line 8B-8B. The two general areas of the heater pillar 48 and ELG pillar 49 are circled and arrows point to their general locations in the cross-sectional view FIG. 8B. The subsequent FIGS. 9-16 are all taken at these same two areas, but show further stages in the fabrication process at these same locations.

FIG. 8B shows a substrate layer 50, having an undercoat layer 52 which is a non-conductive material and the heater layer 54 constructed upon it. The heater layer 54 is preferably NiCr, and has the electrical conductive lead layer 21, preferably of Cu, fabricated upon it. An insulation layer 58 has been formed, and a portion removed to form a gap 60 in the insulation layer 58.

FIG. 9 shows the next stage of fabrication in which a shield 1 layer 62 has been added, as well as further insulation layers 64. It is to be understood that the read and write heads are being built at the same time on a portion of the slider which is not included in this series of views in FIGS. 8-16. Thus the material which acts as the first shield (S1) for the read head is formed at the same time at this other region. For sake of simplicity, the material deposited here will be referred to as an S1 shield material layer, although its function is that of electrical conduction, and not for magnetic shielding. In a similar manner, S2 shield material layer, P1 pole material layer, pedestal material layer, and P2 pole material layer are formed in the subsequent stages to be described below, and will be similarly named, although their function here will be to form electrical pathways of the pillars, and not to form magnetic poles or magnetic shields in the viewed regions.

There are a number of further layers of insulation material applied in subsequent stages, and for the sake of simplicity, will all be referred to as “insulation material 64” which is usually alumina.

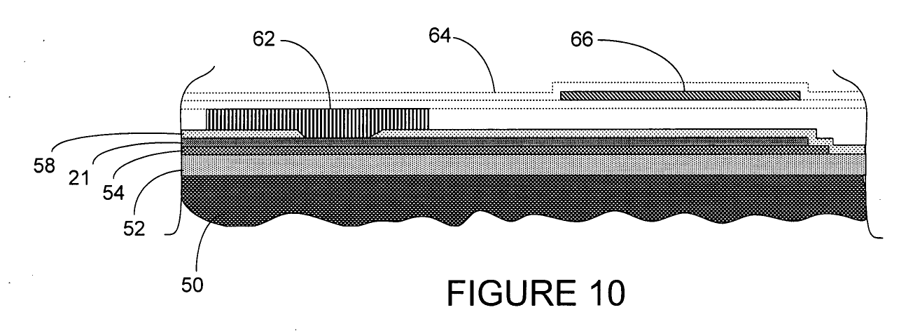

FIG. 10 shows the addition of the ELG lead layer 66, as well as additional insulation material 64.

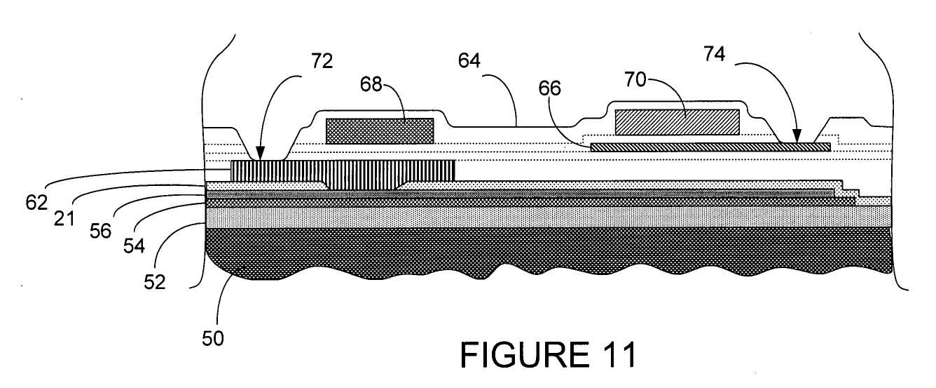

FIG. 11 shows the addition of separation gap 68 and an area of S2 shield material 70, as well as additional insulation material 64. These layers have been etched away to leave an etch gap 72 to the Shield 1 material layer 62, which connects to the conductive lead layer 21 and heater layer 54. There is also an etch gap 74 which opens a pathway to the ELG lead 66.

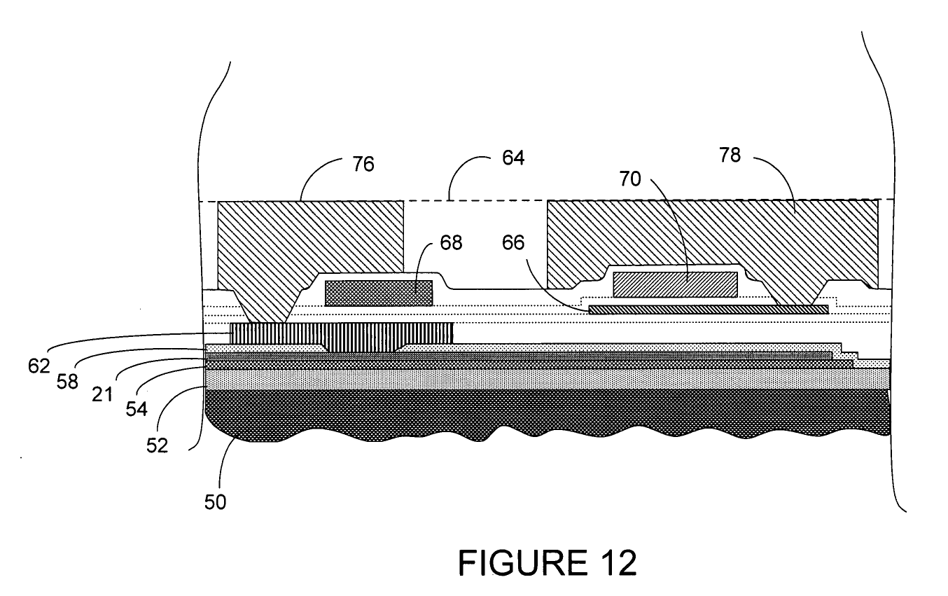

FIG. 12 shows that Pole 1 material layer 76 and P1 material 78 have been added, and are in electrical contact with the heater conductive leads 21 and ELG lead layer 66, respectively. More insulation material 64 has been added between them.

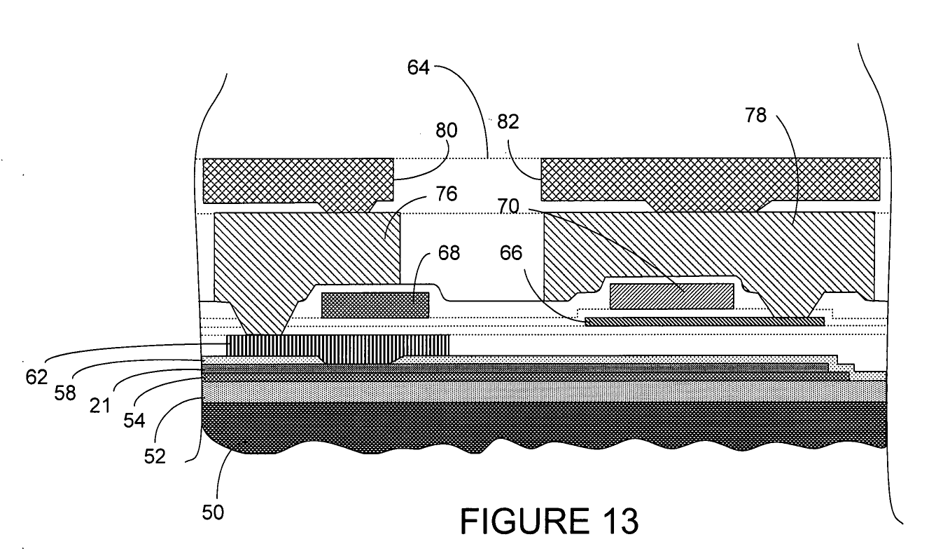

FIG. 13 shows that the pedestal material layer 80 and pedestal material 82 have been added, with insulation material 64 between them.

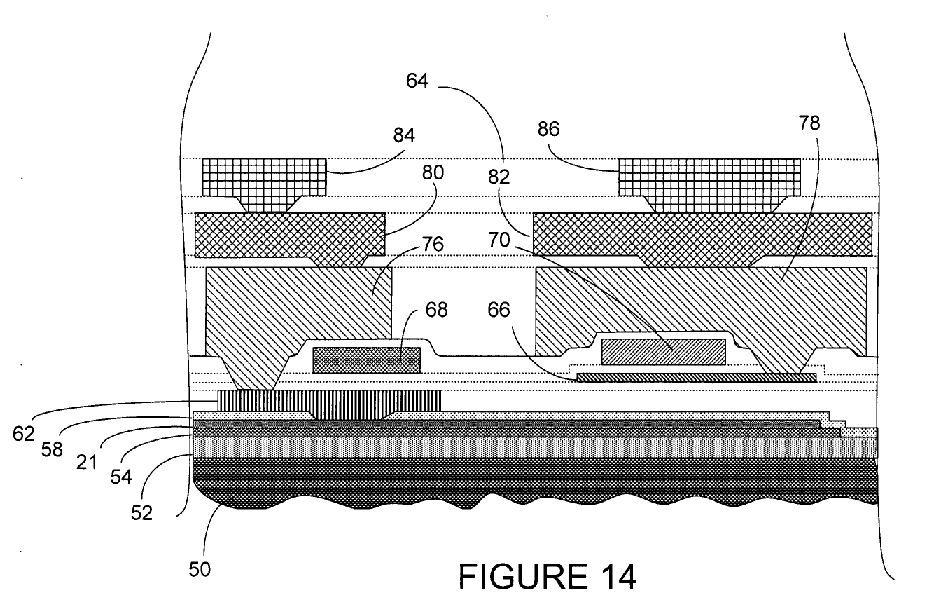

In FIG. 14, P2 material layer 84 and P2 material 86 have been added with insulation material 64 between them.

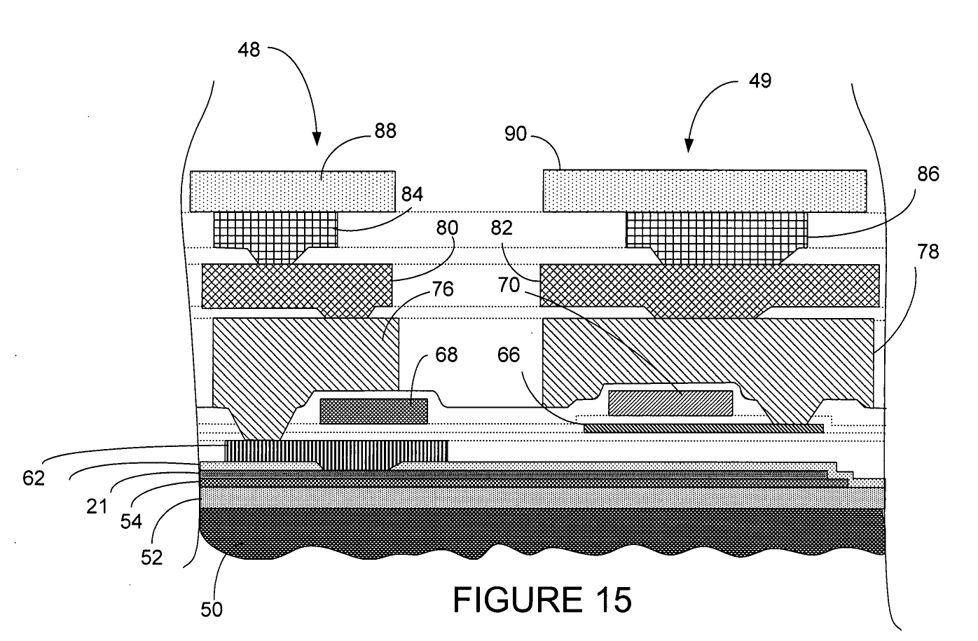

FIG. 15 shows the addition of electrical connectors 88 and 90. This completes the individual heater pillar 48 and ELG pillar 49. It can be seen that the heater pillar 48 includes heater 54, conductive lead layer 21, Shield 1 material layer 62, P1 pole material layer 76, pedestal material 80, P2 pole material 84 and electrical connector 88. The ELG pillar includes ELG leads 66, P1 pole material 78, pedestal material 82, P2 pole material 86 and electrical connector 90. At this stage, the two circuits are independent of each other, and have no common electrical connection. The individual resistance of R_{ELG} can now be measured for use in calculating the R_{Heater} 11 R_{ELG} and R_{Heater} 11 R_{ELGmod} values.

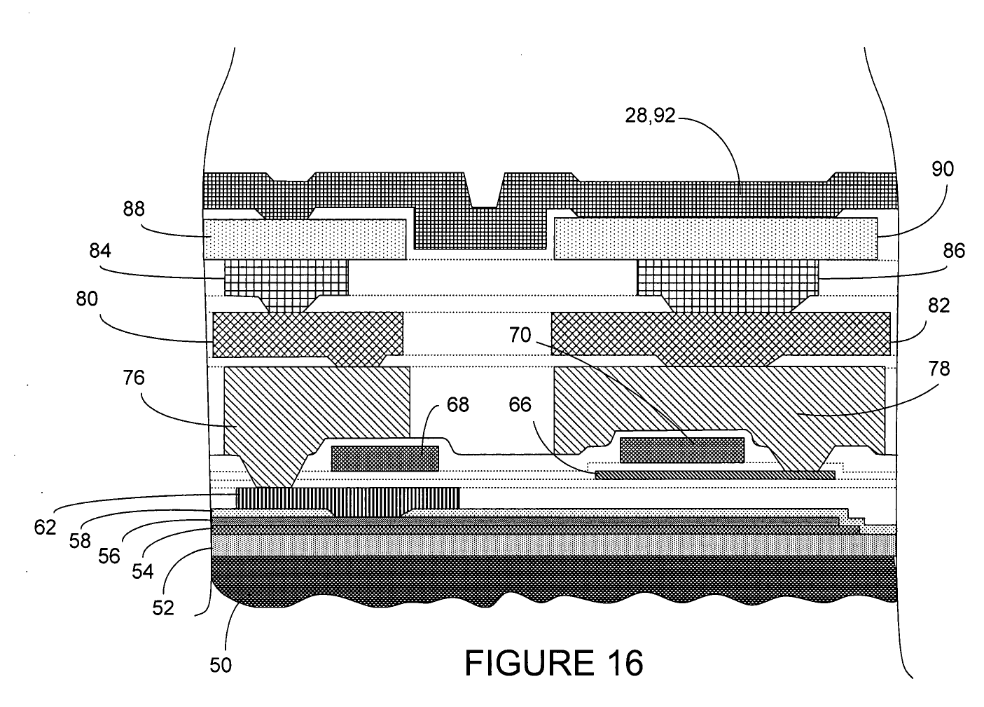

FIG. 16 show the final stage of this sequence, in which the pad 92, corresponding to pad 28 in FIG. 4, is added, which makes electrical contact with electrical connectors 88 and 90, and thus links the two ELG and TFC electrical circuits in parallel.

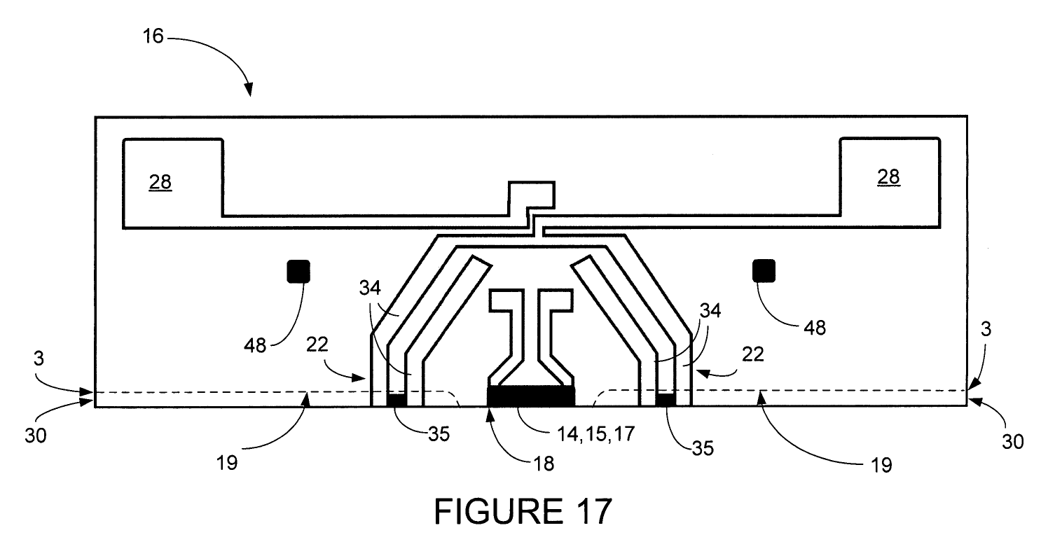

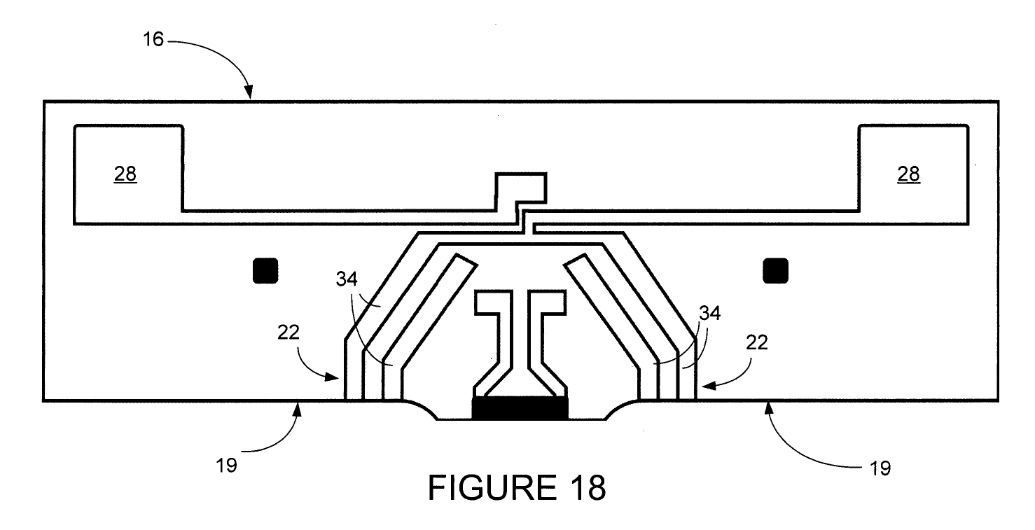

FIG. 17 shows a top view of the slider 16 after lapping of the ABS 18 in the region of the write heads 14 has been performed, but before the patterning of the ABS. The magnetic heads 14, including the read head 15, write head 17 are indicated. The ELGs 22 are shown, which include the ELG leads 34 and the ELG resistor 35 linking the ELG leads 34. As discussed before, the ELG resistor 35 extended partially or completely into the removal area 29 (see FIG. 4), which has now been removed. Dashed lines 3 indicate the extent of the etch region 30 which still remains to be removed. The projected extent of the patterned ABS in these areas is indicated by the element number 19 in this figure. The ELG's connection to the contact pads 28 is not completely visible, and only a portion of the heater pillars 48 are visible.

Previously, the R_{Heater} 11 R_{ELG} has been measured and correlated to the individual resistances of R_{Heater} and R_{ELG} measured in the previous stage. A target value for the final R_{Heater} 11 R_{ELGmod} combination has been determined based on the measured value of the R_{Heater} and the calculated value of R_{ELGmod} when the lapping of the ABS has reached completion. The lapping process has been performed and the parallel resistance combination R_{Heater} 11 R_{ELG} has been monitored at the contact pads 28. The resistance R_{Heater} 11 R_{ELG} has been monitoring until it reaches the calculated R_{Heater} 11 R_{ELGmod}, and thus it has been determined that the lapping process has reached the appropriate depth, and is thus complete.

Thus, the lapping process continues until the measured R_{Heater} 11 R_{ELGmod} approximates the target R_{Heater} 11 R_{ELGmod} but is not intended to equal the value exactly. It is estimated that if the measured R_{Heater} 11 R_{ELGmod} approximates the target R_{Heater} 11 R_{ELGmod} to within plus or minus 1% the operation may be deemed completed.

FIG. 18 shows the slider 16 after lapping and patterning has established the final patterned ABS 19. A portion, or preferably, all of the resistor element connecting the two leads 34 of the ELG 22 has been removed, leaving an open circuit in parallel with the R_{Heater}, thus theoretically equal to the resistance of the heater alone, when measured at pads 28.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

What is claimed is:

1. A slider for a magnetic disk drive, comprising:
a heater circuit structure;
at least one ELG circuit structure, said at least one ELG circuit structure being connected electrically in parallel with said heater circuit structure to a common set of electrical contact pads.

2. The slider of claim 1, wherein the electrical resistance of said ELG circuit structure is that of an open circuit.

3. The slider of claim 2, wherein:
said ELG circuit structure includes an ELG pillar.

4. The slider of claim 3, wherein;
said heater circuit structure includes a heater pillar.

5. The slider of claim 4, wherein:
said ELG pillar is connected to said heater pillar at said common set of contact pads to establish the electrically parallel connection.

6. The slider of claim 3, wherein said ELG pillar comprises:
an ELG lead layer;
a P1 material layer formed on said ELG lead layer;
a pedestal material layer formed on said P1 material layer;
a P2 layer material layer formed on said pedestal material layer; and
an electrical connection layer formed on said P2 material layer.

7. The slider of claim 4, wherein said heater pillar comprises:
a heater layer;
an S1 material layer formed on said heater layer;
a P1 material layer formed on said S1 material layer;
a pedestal material layer formed on said P1 material layer;
a P2 material layer formed on said pedestal material layer; and
an electrical connection layer formed on said P2 material layer.

8. A disk drive comprising:
at least one hard disk;
a slider adapted to fly over said hard disk for writing data on said hard disk, and having an air bearing surface, said slider including:
a heater circuit structure; and
at least one ELG circuit structure where a portion of said ELG circuit stricture is removable by lapping, and said at least one ELG circuit structure is connected electrically in parallel with said heater circuit structure to a common set of electrical contact pads.

9. The disk drive of claim 8, wherein the electrical resistances of said ELG and said heater produce a measured initial parallel resistance as measured at said common set of electrical contact pads, a modified parallel resistance is calculated to correspond to that of the modified individual resistance of said ELG when lapping operation is completed, and said resistance is monitored during lapping operations to signal when the appropriate lapping depth is achieved.

10. The disk drive of claim 8, wherein:
said ELG circuit structure includes a ELG pillar.

11. The disk drive of claim 8, wherein;
said heater circuit structure includes a heater pillar.

12. The disk drive of claim 10, wherein:
said ELG pillar is connected to said heater pillar at said common set of contact pads to establish the electrically parallel configuration.

13. The disk drive of claim 10, wherein said ELG pillar comprises:
an ELG lead layer;
a P1 material layer formed on said ELG lead layer;
a pedestal material layer formed on said P1 material layer;
a P2 material layer material layer formed on said pedestal material layer; and
an electrical connection layer formed on said P2 material layer.

14. The disk drive of claim 11, wherein said heater pillar comprises:
a heater layer;
an S1 material layer formed on said heater layer;
a P1 material layer formed on said S1 material layer;
a pedestal layer formed on said P1 material layer;
a P2 material layer formed on said pedestal material layer; and
an electrical connection layer formed on said P2 material layer.

15. A method of fabrication for a slider for a magnetic disk drive, comprising:
A) constructing at least one ELG circuit structure such that a portion of said ELG circuit structure lies in a material removal area of said slider;
B) constructing at least one heater circuit structure in said slider which is electrically initially isolated from said ELG circuit structure;
C) measuring individual resistances of said ELG circuit structure and said heater circuit structure;
D) connecting said ELG circuit structure and said heater circuit structure at a single set of contact pads in electrically parallel combination to produce a parallel resistance;
E) determining a target parallel resistance of said electrically parallel combination when said appropriate final depth of material removal has been achieved;
F) monitoring said parallel resistance at said single set of contact pads; and
G) removing material until said monitored parallel resistance approximates said target parallel resistance, and thus said appropriate final depth of material removal has been achieved.

16. A method of fabrication for a slider for a magnetic disk drive, comprising:
A) constructing at least one ELG circuit structure including at least one ELG pillar;
B) constructing at least one heater circuit structure including at least one heater pillar, where said at least one heater circuit structure is electrically isolated from said ELG circuit structure; and
C) connecting said ELG pillar and said heater pillar in electrically parallel configuration to a single pair of contact pads.

17. The method of fabrication of claim 16, wherein:
A) includes constructing a portion of said ELG circuit structure to lie in a material removal area of said slider.

18. The method of fabrication of claim 17, further comprising:
D) monitoring the electrical resistance of said ELG circuit structure and said heater circuit structure connected in electrically parallel combination at said single pair of contact pads;
E) determining a target parallel resistance of said electrically parallel combination when said appropriate final depth of material removal has been achieved;
F) removing material until said target parallel resistance is achieved, and thus said appropriate final depth of material removal has been achieved.

19. The method of fabrication of claim 18, wherein:
F) includes removing all or a portion of said ELG circuit structure which lies in said material removal area of said slider.

20. The method of fabrication of claim 19, wherein:
etch region material is removed such that said ELG circuit structure becomes an open circuit, and the parallel resistance value of the electrically parallel combination of said ELG circuit structure and said heater circuit structure approximates that of said heater structure alone.
